(19) United States
(12) Patent Application Publication
(10) Pub. No.: US 2014/0313568 A1
(43) Pub. Date: Oct. 23, 2014

(54) HYPER-HEMISPHERICAL BEAM ANGLE MAGNIFIER

(71) Applicant: RAYTHEON COMPANY, Waltham, MA (US)

(72) Inventor: Irl W. Smith, Concord, MA (US)

(73) Assignee: RAYTHEON COMPANY, Waltham, MA (US)

(21) Appl. No.: 13/865,401

(22) Filed: Apr. 18, 2013

(51) Int. Cl. G02F 1/29

(52) U.S. Cl. CPC G02F 1/292
USPC 359/298

(57) ABSTRACT

A beam director system configured to steer an optical beam over a hyper-hemispherical field of regard. In one example a beam director includes a pre-director configured to steer an optical beam over a first field of regard, and a beam angle magnifier that includes a beam directing apparatus and a field-of-regard switch, the beam angle magnifier configured to expand the first field of regard to a second field of regard larger than the first field of regard, wherein the beam directing apparatus is configured to receive the optical beam from the pre-director and to alter a pointing direction of the optical beam, and the field-of-regard switch configured to receive the optical beam from the beam directing apparatus, and to direct the optical beam into one of first and second bands of coverage within the second field of regard. The beam angle magnifier may be disposed within a rotatable housing.

### BACKGROUND

Beam directors suitable for mobile platforms (e.g., aircraft) and used for directed energy, active sensors (such as LADAR, for example), or laser communications face conflicting requirements of compactness, conformality, and large field of regard. Generally, a conformal beam director that steers a beam through a flat or gently curved window cannot cover more than about ±50° from the normal to the window. Systems that can achieve larger coverage (field of regard) up to or exceeding ±90°, for example, are typically bulky and/or highly non-conformal. For example, one approach is to use a gimbaled system which is usually housed in a turret mounted external to the airframe of the host aircraft and which often incorporates a coudé optical path with many optical elements. Another approach involves the use of two minors rotating about different axes, sometimes referred to as a two-minor coelostat. One mirror is typically positioned at a fixed angle, for example, 45°, to the fixed beam incident from within the platform and is on the rotation axis of a large rotatable housing, and a second minor is positioned at 45° relative to the beam reflected from the first minor and rotatable about the axis of that beam. The combination of the two rotations allows for hemispherical coverage. However, this type of system includes a large structure located outside of the airframe, along with the need to supply cables to the rotating housing. In addition, the mirrors must be rotated very precisely. A system similar to the two-mirror coelostat configuration uses a refractive beam director, such as a Risley prism pair, carried on a large turntable, as disclosed for example in U.S. Pat. No. 7,236,299. Another example of a beam director system is disclosed in U.S. Pat. No. 7,336,407; however, in this system the beam size is very small relative to the size of the external structure. Another approach includes the use of an extreme fisheye lens. Although the portion of the fisheye lens positioned outside of the body of the aircraft may be relatively unobtrusive, the beam diameter is only a small fraction of the overall lens size.

Thus, conventional beam directors capable of hyper-hemispherical fields of regard are very bulky and non-aerodynamic, leading to turbulence-induced (aero-optical) beam distortion as well as drag reducing the performance/range of the aircraft, have small beam diameters, and/or are highly non-conformal.

### SUMMARY OF INVENTION

Aspects and embodiments are directed to a compact beam director that includes a beam angle magnifier to achieve hyper-hemispherical coverage. As discussed in more detail below, polarization gratings, and optionally prisms, may be used in the beam angle magnifier to achieve large angular coverage in a compact, conformal system.

According to one embodiment, a beam director comprises a pre-director having a first field of regard and configured to steer an optical beam over the first field of regard, a beam angle magnifier coupled to the pre-director and including a beam directing apparatus and a field-of-regard switch, the beam angle magnifier configured to expand the first field of regard to a second field of regard larger than the first field of regard, wherein the beam directing apparatus is configured to receive the optical beam from the pre-director and to alter a pointing direction of the optical beam, and the field-of-regard switch configured to receive the optical beam from the beam directing apparatus, and to direct the optical beam into one of first and second bands of coverage within the second field of regard, and a rotatable housing, the beam angle magnifier being disposed within the rotatable housing.

In one example, the field-of-regard switch includes a polarization grating and is configured to direct the optical beam into the one of the first and second bands of coverage based on a polarization of the optical beam. In one example the beam directing apparatus includes at least one prism. The beam directing apparatus may include three prisms optically coupled together in series, each configured to alter the pointing direction of the optical beam by a predetermined amount. In another example the field-of-regard switch further includes a half-wave plate coupled to the polarization grating. In one example the beam directing apparatus includes at least one additional polarization grating. The beam directing apparatus may include two additional polarization gratings optically coupled together in series, each configured to alter the pointing direction of the optical beam by a predetermined amount. In one example the half-wave plate is a liquid crystal switchable half-wave plate. The beam director may further include a window coupled to the rotatable housing and optically transmissive to the optical beam. In one example the second field of regard is at least ±60°. In another example, the second field of regard is at least ±90°. In another example the first field of regard is approximately ±18° and the second field of regard is at least ±90°. In another example the first field of regard is approximately ±20° and the second field of regard is at least ±90°. The pre-director may include a two-dimensional beam steering apparatus. In another example the pre-director includes one of a single prism and a single grating configured to steer the optical beam along a circular or oval path.

According to another embodiment, a method of beam-steering in an optical system comprises steering an optical beam over a first field of regard with a pre-director, receiving the optical beam from the pre-director and deflecting the optical beam to expand the first field of regard to a second field of regard larger than the first field of regard, and directing the optical beam with a polarization grating into one of first and second bands of coverage within the second field of regard based on a polarization of the optical beam.

In one example deflecting the optical beam includes passing the optical beam through at least one prism. Directing the optical beam may further include switching the polarization of the optical beam with a switchable half-wave plate positioned optically before the polarization grating to select the one of the first and second bands of coverage. In another example deflecting the optical beam includes passing the optical beam through at least one additional polarization grating, and wherein the switchable half-wave plate is positioned between the polarization grating and the at least one additional polarization grating.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is a diagram of one example of a beam director according to aspects of the invention;

FIG. 2 is a diagram of another example of a beam director according to aspects of the invention;

FIG. 3 is a diagram of an example of the beam director of FIG. 1 demonstrating an ability to achieve hyper-hemispherical coverage according to aspects of the invention;

FIG. 4A is a diagram illustrating, in angle space, a field of regard of the pre-director of a beam director system according to aspects of the invention;

FIG. 4B is a diagram illustrating, in angle space, the field of regard of the pre-director after application of a beam bender comprised within a beam director system according to aspects of the invention;

FIG. 4C is a diagram illustrating, in angle space, movement of the field of regard of pre-director responsive to switching by the field-of-regard switch of a beam director system according to aspects of the invention;

FIG. 4D is a diagram illustrating, in angle space, an example of the field of regard achievable using an embodiment of the beam director of FIGS. 1 and 3 according to aspects of the invention; and

FIG. 5 is a diagram of another example of a beam director demonstrating an ability to achieve hyper-hemispherical coverage according to aspects of the invention;

### DETAILED DESCRIPTION

For various aircraft-based optical systems, it is desirable to achieve coverage over a field of regard (FoR) of a hemisphere or more with a large steered beam, while having as small as possible a structure, particularly that part of the structure located external to the aircraft (or other platform). However, as discussed above, conventional beam directors with a large field of regard are generally bulky and non-aerodynamic, support only very small beam diameters, and/or are highly non-conformal. Aspects and embodiments are directed to a compact beam director structure that maintains a large usable beam diameter and may provide hyper-hemispherical coverage. In particular, certain embodiments incorporate the use of polarization gratings to achieve significant (for example, two to three times) reduction in the size of the beam director system relative to conventional systems for the same beam diameter, as well as a more conformal approach. As discussed in more detail below, one or more polarization gratings disposed in a rotatable housing are used to “flip” or switch between two bands of beam-pointing directions, thereby allowing a beam “pre-director” having modest field of regard to cover more than a hemisphere. Circularly polarized light incident on a polarization grating is deflected, with very high efficiency, by an angle whose magnitude depends on the design of the polarization grating. If the incident light is left circularly polarized (LCP), the deflection is in one direction (for example, to the right by a certain number of degrees), and if the light is right circularly polarized (RCP), the deflection is in the opposite direction (for example, to the left by the same number of degrees). Those skilled in the art will appreciate that the deflection angles also depend somewhat on the angle of incidence of the light on the polarization grating. This concept is described in more detail in “Wide-angle, non-mechanical beam steering using thin liquid crystal polarization gratings,” Jihwan Kim et al., Proceedings of SPIE, Vol. 7093. A half-wave plate changes RCP light into LCP light, and vice versa. Thus, for example, a rotatable beam angle magnifier incorporating the polarization grating(s) may be applied to the output of any beam-steering mechanism (referred to herein as the “pre-director”) having a field of regard of about ±20° to expand the coverage to >±60°, and optionally >±90°. The combination of a beam bender and a polarization grating configured to switch the output of the beam bender zenithwards or horizonwards, both located in a rotatable housing, enables placing of the field of regard of the pre-director anywhere within a large range of angular space, as discussed further below.

It is to be appreciated that embodiments of the methods and apparatuses discussed herein are not limited in application to the details of construction and the arrangement of components set forth in the following description or illustrated in the accompanying drawings. The methods and apparatuses may be implemented in other embodiments and may be practiced or carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to left and right, or vertical and horizontal are intended for convenience of description, not to limit the present systems and methods or their components to any one positional or spatial orientation.

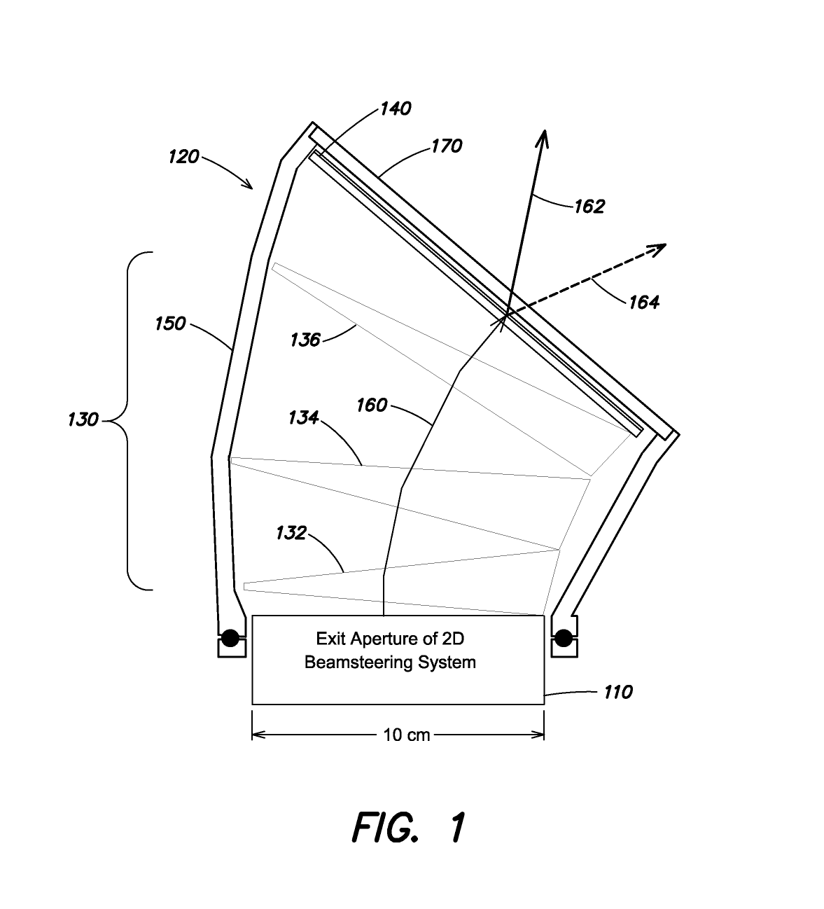

Referring to FIG. 1, there is illustrated one example of a beam director system according to one embodiment. The system includes a pre-director 110 and a beam angle magnifier 120 optically coupled to the pre-director. The beam angle magnifier 120 includes a beam directing apparatus 130, also referred to as a beam bender, and a field-of-regard (FoR) switch 140, both mounted in a rotatable housing 150. In one embodiment, the rotatable housing 150 includes a rotary joint the axis of which coincides with a boresight direction of the underlying pre-director 110, which may be taken to be vertical for the purposes of the following description. Ray 160 represents the path of the boresight primary (central) ray from the pre-director 110. As used herein, the term “ray” refers to a representation of a mathematical definition of a directed line, i.e., a very thin piece of an optical beam, and the term “beam” refers to a collection of rays, generally traveling substantially parallel to each other.

The housing 150 may include or be coupled to a window 170 through which the rays pass into object space. In one embodiment the window 170 is preferably flat since a flat window introduces less optical distortion than does a dome shaped window. The window 170 is made from a material that is transmissive (or substantially optically transparent) to electromagnetic radiation in one or more wavelength ranges of interest, such as the visible, infrared and/or ultraviolet spectral bands, for example.

According to certain embodiments, the pre-director 110 may include any type of beam steering mechanism. In one embodiment, the pre-director 110 includes a two-dimensional beam steering device having coverage of up to approximately ±20°. For example, the pre-director 110 may include a single one or a phase-locked array of small apertures with adaptive correction of phase distortions incorporated directly into each aperture. Such a system, if multi-aperture, is known as adaptive photonics phase-locked element (“APPLE”) array, and includes an array of apertures capable of transmitting and steering spatially phased optical energy. In other examples the pre-director 110 may include a Risley beam steering system using one or more prisms or polarization gratings. Polarization gratings that are electronically controlled can be used to allow steering of optical beams transmitted through them. Examples of beam steering apparatuses using polarization gratings are described in co-pending, commonly-owned U.S. Pre-grant Patent Publication No. 2012/0081621 filed on Sep. 30, 2011 and titled “HIGH FILL-FACTOR ELECTRONIC BEAM STEERER.”

The beam bender 130 accepts an optical beam from the exit aperture of the pre-director 110 and directs the beam to the field-of-regard switch 140. For example, the beam bender 130 may provide a mechanism by which to bend the nominally zenith-centered field of regard of the pre-director 110 (represented by primary ray 160) to an angle of approximately 45°, as illustrating in FIG. 1. However, the beam bender may bend the field of regard by any angular amount, not limited to 45°. The field-of-regard switch 140 then further bends or directs the center of the field of regard either towards the zenith (as illustrated by ray 162) or towards the horizon (as illustrated by ray 164). As discussed above, the beam angle magnifier 120 is disposed in a rotatable housing 150 such that by using the beam bender 130 and field-of-regard switch 140, and rotating the rotatable housing 150, the field of regard of the pre-director 110 may be shifted over a large, preferably hyper-hemispherical, angular range.

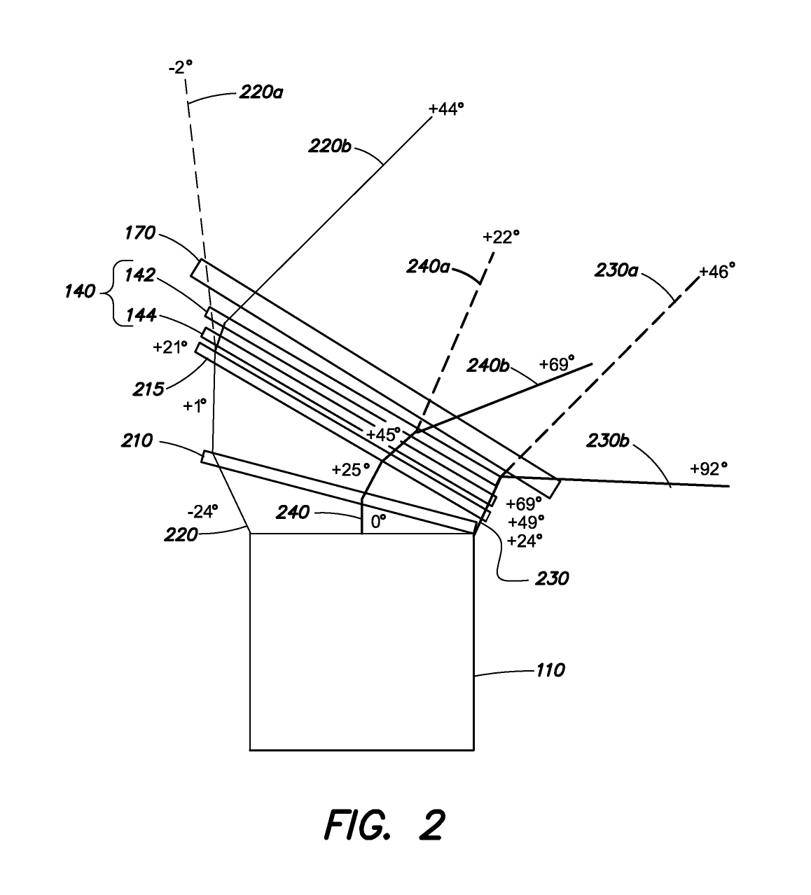

According to one embodiment, the beam bender 130 includes one or more prisms, each prism configured to alter the angle or pointing direction of the optical beams from the pre-director. In the example illustrated in FIG. 1, the beam bender 130 includes three prisms 132, 134, and 136. However, those skilled in the art will appreciate, given the benefit of this disclosure, that the number of prisms may vary depending, for example, on the desired angular shift of the optical beams, and the thickness and configuration of the prisms, and is not limited to three. According to other embodiments, the beam bender 130 may include one or more polarization gratings instead of the prisms, or in addition to one or more prisms. FIG. 2 illustrates one example of a beam director in which the beam bender includes two polarization gratings 210, 215, each configured to deflect the optical beam by a predetermined amount, as discussed further below.

The field-of-regard switch 140 includes at least one polarization grating, and optionally at least one switchable half-wave plate. In the example illustrated in FIG. 2, it may be necessary for proper operation of the beam bender that the polarization of the optical beam passing through and being deflected by the polarization gratings 210, 215 remain fixed. Accordingly, in this and similar embodiments, the field-of-regard switch 140 includes a polarization grating 142 and a switchable half-wave plate 144. The switchable half-wave plate 144 is used to switch the polarization of the incoming optical beam between two different polarizations, for example, from left-hand circular polarization to right-hand circular polarization, or vice versa. In one example, the switchable half-wave plate 144 is a liquid crystal half-wave plate, and the polarization grating 142 is a single passive polarization grating. In other embodiments, the switchable half-wave plate may be placed earlier in the optical train, for example, in the non-rotating portion of the system, if the beam bender 130 is substantially polarization-agnostic. In one example, the switchable half-wave plate may be placed within the pre-director if the componentry in the optical train downstream of the switchable half-wave plate is substantially polarization-agnostic, as may be the case for prisms and lenses with proper care in the design and fabrication. This configuration (in which the switchable half-wave plate is not located in the rotating portion of the system) may be preferable since it avoids having a large-aperture switchable half-wave plate (or other controlled components) in the rotating housing, and is therefore mechanically simpler. Additionally, it allows the polarization switching to be accomplished when the beam diameter is smaller, which may be desirable if there are more stringent limits on the practically-manufacturable maximum size of switchable half-wave plates than of polarization gratings.

Based on the polarization of the optical beam incident on the polarization grating 142 of the field-of-regard switch 140, the polarization grating directs the beam either zenithwards or horizonwards, as shown by rays 162 and 164, respectively, in FIG. 1. The polarization grating 142 may be configured to deflect the incident optical beam by a predetermined amount. In one example, the polarization grating 142 is passive, and the degree of angular deflection may be fixed. In another example, the polarization grating 142 may be electronically controllable to produce a switchable angular deflection of the optical beam. As is known in the art, an active polarization grating may be designed to switch between full and zero deflection, with the full-deflection state deflecting RCP in one sense and LCP in the opposite sense. In another example, the polarization grating 142 may include a plurality of gratings, each configured to provide a certain angular deflection of the optical beam, which may be selectively activated to control the overall angular deflection applied to the optical beam. Although configuring the polarization grating 142 to include one or more active polarization gratings may require additional control lines to be run into the rotatable housing 150, thereby adding mechanical complexity, a benefit obtained is additional control over the beam steering. For example, a system with an active polarization grating 142 may support three zones of coverage, namely near-zenith, near-horizon, and intermediate, which may support the use of a simpler, or less-capable (e.g., smaller field of regard) pre-director 110.

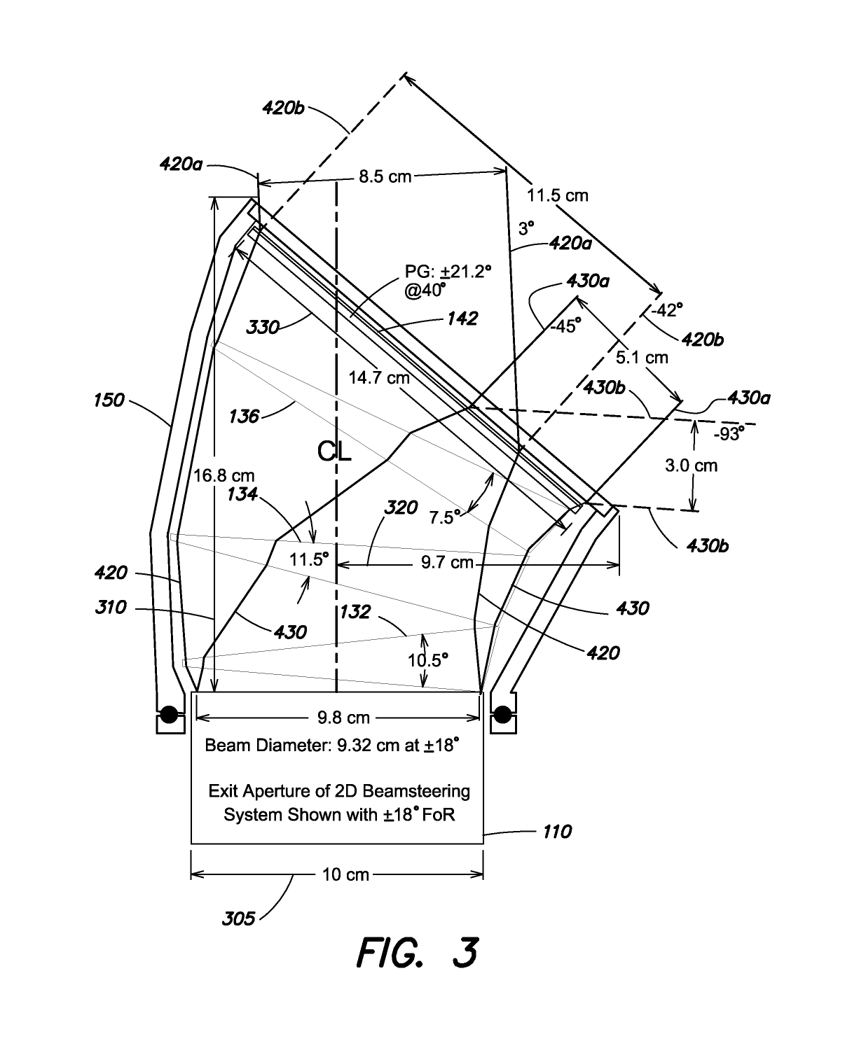

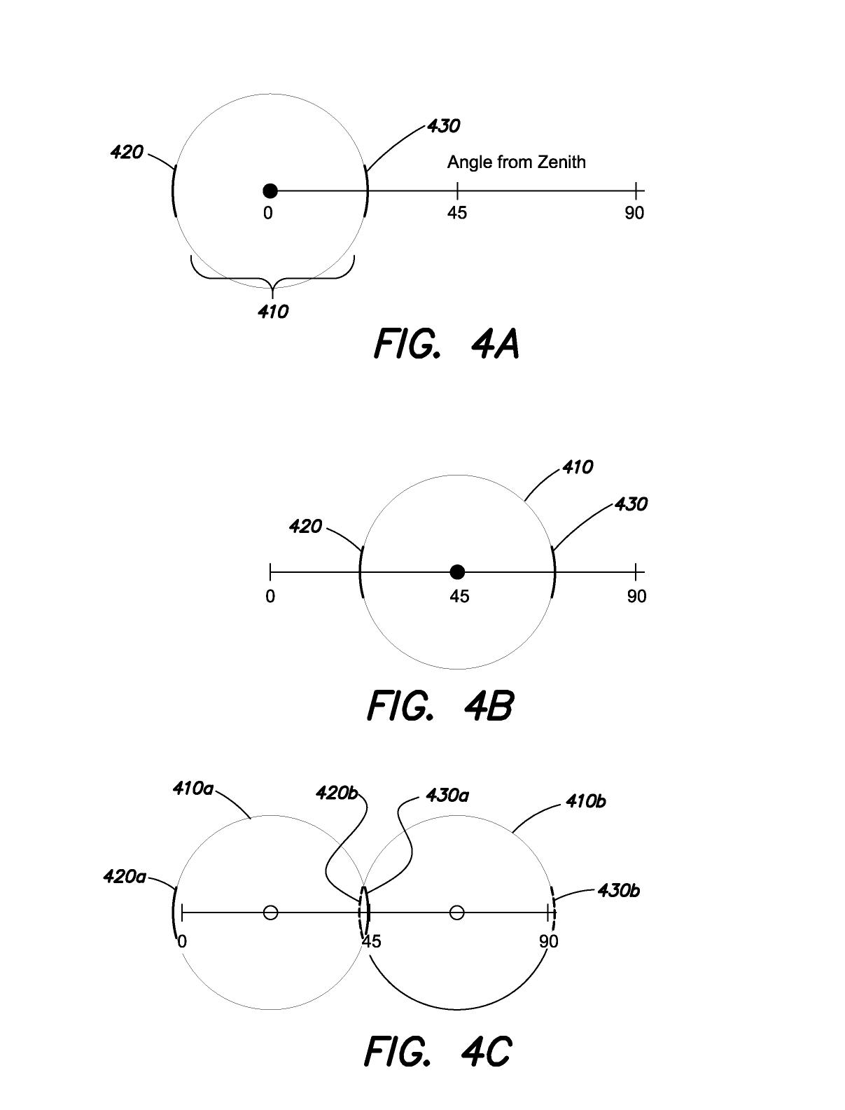

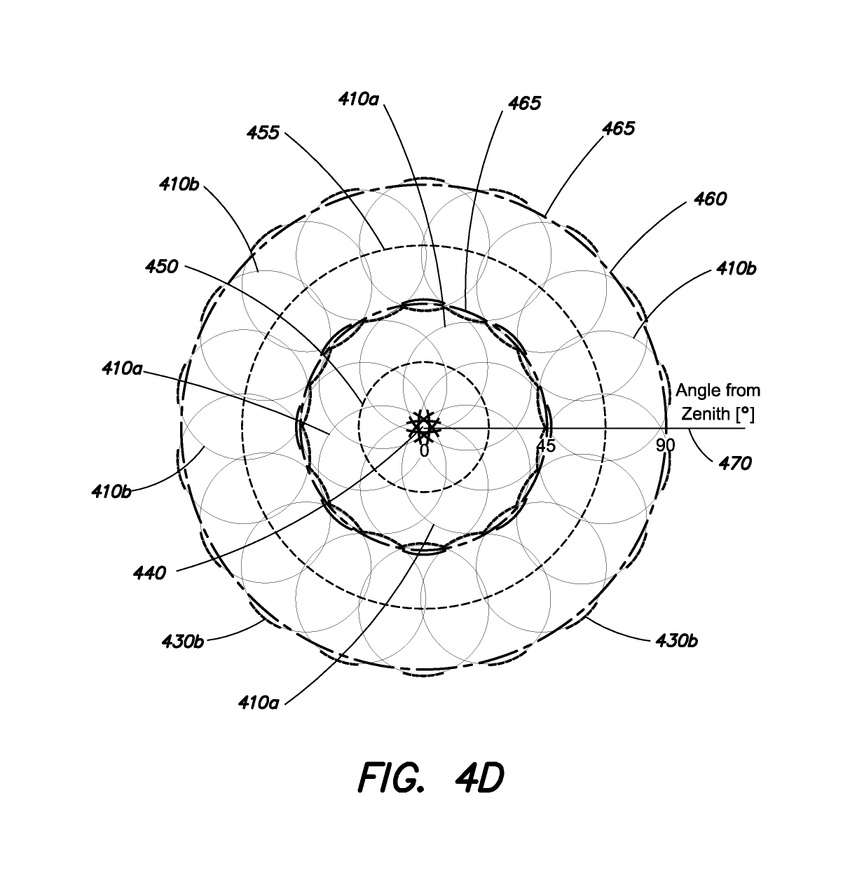

FIG. 3 illustrates an example of the beam director of FIG. 1 showing some numerical examples of the configuration of various components of the beam director system selected to achieve hyper-hemispherical coverage. It is to be appreciated that the examples discussed herein and illustrated in FIG. 3 and other figures are exemplary only, and not intended to be limiting. In the example shown in FIG. 3, the pre-director 110 is steerable in two dimensions (azimuth and elevation) with a field of regard of covering a cone of half-angle 18°, and has exit aperture diameter 305 of 10 centimeters (cm). In this example, the beam diameter is 9.32 cm at ±18°. Thus, referring to FIG. 4A, the pre-director 110 steers the optical beams over a ±18° circle 410 that represents the total coverage are of the pre-director. Line 420 represents the edge of the field of regard 410 when the pre-director 110 is steering approximately maximally leftwards, and line 430 represents the edge of the field of regard 410 when the pre-director 110 is steering approximately maximally rightwards. In FIG. 3, the lines on the left portion of the figure show individual rays emitted at the left edge of the optical aperture of the pre-director, while the lines on the right portion of the figure show individual rays emitted at the right edge of the optical aperture of the pre-director. In FIG. 3 such similarly-numbered rays are traveling substantially parallel to one another. In FIGS. 4A-D each such ray is shown only as a single point in angle-steering space.

Referring again to FIG. 3, the first prism 132 is configured with an angle of 10.5° and bends the optical rays (420/430) by a first amount. The second prism 134 is configured with an angle of 11.5° and bends the optical rays by a further second amount, and the third prism 136, configured with an angle of 7.5° bends the optical rays by a further third amount. Thus, after passing through the beam bender 130, the field of regard of the pre-director 110 is shifted from approximately centered on the zenith to approximately 45° from zenith, as shown in FIG. 4B. The field-of-regard switch 140 then bends or directs the optical rays either zenithwards or horizonwards, as discussed above. In the example illustrated in FIG. 3, the field-of-regard switch 140 is positioned at an angle of 40° relative to the zenith, and includes a polarization grating configured to bend the optical rays 21.2° in either direction. As will be appreciated by those skilled in the art, given the benefit of this disclosure, the deflection angles stated herein are nominal values for rays incident from a particular direction, and since, as is well known, the deflection for a prism or grating depends on the angle of incidence, the stated deflection angles may vary from the nominal value. Additionally, aspects and embodiments are not limited to the numerical examples given herein, and a wide variety of deflection angles may be selected and implemented, depending, for example, on the intended application.

Referring to FIG. 3 and to FIG. 4C, with the field-of-regard switch 140 configured to direct the optical beams zenithwards, lines 420a and 430a represent the edges of the field of regard 410a respectively corresponding to left steering and right steering of the optical beams by the pre-director 110. With the field-of-regard switch 140 configured to direct the optical beams horizonwards, lines 420b and 430b represent the edges of the field of regard 410b respectively corresponding to left steering and right steering of the optical beams by the pre-director 110. Movement of the field of regard 410 of the pre-director corresponding to operation of the field-of-regard switch 140 is thus illustrated schematically in FIG. 4C. The full field of regard is obtained by rotating the beam angle magnifier 120 about the zenith 440, as illustrated in FIG. 4D. Lines 450 and 455 represent the centers of the two “bands” of coverage respectably corresponding to the two states of the FoR switch 140. Line 460 represents the horizon (90° from the zenith). Line 465 represents directions at an angle of 45° to the zenith. Axis 470 represents the angle from zenith. Remaining circles 410a, 410b represent some of the different possible locations of the FoR 410 after passing through the beam angle magnifier when the latter is rotated to various angles. The illustration in FIG. 4D ignores the effect of anamorphic magnification which in practice would result in the actual shifted fields of regard (represented by circles 410) being slightly oval, rather than truly circular. It should be noted that the aspects and embodiments described herein provide full hyperhemispherical coverage even if the pre-director steers only on the edges of FoR 410, as would be the case, for example, if the pre-director were a single rotatable prism or grating.

In the example illustrated in FIG. 3, the field of regard of the system extends from +3° (i.e., 3° beyond or “left” of the zenith) to −93° (i.e., 3° beyond or “right” of the horizon), thus achieving hyper-hemispherical coverage. A first band of coverage, corresponding to zenithwards steering of the optical beams by the FoR switch, extends from +3° to −45° (bounded by lines 420a and 430a and centered around line 450), and a second band of coverage, corresponding to horizonwards steering of the optical beams by the FoR switch, extends from −42° to −93° (bounded by lines 420b and 430b and centered around line 455). It will be noted that the two bands overlap between −42° and −45°, and thus directions in this region of angle space may be accessed with the FoR switch in either state and there is no gap in the angular coverage. As discussed above, in some conventional beam director systems the beam size is very small relative to the size of the external structure. In contrast, beam director systems according to various embodiments discussed herein maintain a relatively large beam size. For example, referring to FIG. 3, for a beam diameter of 9.32 cm at the exit aperture of pre-director, steered at ±18°, the beam diameter exiting the window 170 ranges between 3.0 cm (corresponding to right steering of the beam by the pre-director 110 and horizonwards directing of the beam by the field-of-regard switch 140) and 11.5 cm (corresponding to left steering of the beam by the pre-director 110 and horizonwards directing of the beam by the field-of-regard switch 140). For left steering of the beam by the pre-director 110 and zenithwards directing of the beam by the field-of-regard switch 140, the beam diameter in this example is 8.5 cm, and for right steering of the beam by the pre-director 110 and zenithwards directing of the beam by the field-of-regard switch 140, the beam diameter in this example is 5.1 cm. The dimensions of the corresponding structure for this example are 16.8 cm (height 310) by 9.7 cm (radius 320) with a linear dimension 330 of 14.7 cm for the field-of-regard switch 140. Thus, for each of the extreme (“limit”) configurations of the system (i.e., maximum left and right steering of the optical beams by the pre-director 110), the beam diameter remains comparable to the dimensions of the beam director structure. In addition, the beam director structure is relatively compact, and is operable with a flat window 170.

Referring again to FIG. 2, as discussed above, in certain embodiments, the beam bender 130 may be implemented using one or more polarization gratings, and in this case, the field-of-regard switch 140 includes both the polarization grating 142 and switchable half-wave plate 144. For example, as shown in FIG. 2, the beam bender includes two polarization gratings 210, 215. In the example illustrated schematically in FIG. 2, the pre-director 110 is a two-dimensional beam steering apparatus configured to steer the optical beams over ±24° in azimuth and ±5° in elevation. The system, including the polarization gratings making up the beam bender and the field-of-regard switch 140, may be configured to steer the optical beams over hyper-hemispherical coverage, for example, −2° to +92°. As with embodiments of the beam bender implemented using prisms as discussed above, the number and configuration (e.g., amount of angular deflection) of the polarization grating(s) used may vary depending on numerous factors including, for example, the total desired angular deflection, and size constraints of the system. In one example, the field-of-regard switch 140 may be configured to provide approximately ±23° of deflection. In the example illustrated in FIG. 2, ray 220 represents the optical beam steered at the left steering limit (e.g., −24°) from the pre-director 110, which is deflected by the first polarization grating 210 and then further deflected by the second polarization grating 215, and incident on the field-of-regard switch 140. As discussed above, the field-of-regard switch 140 may deflect the optical beam either zenithwards or horizonwards, depending on the polarization of the optical beam which may be influenced by the half-wave plate 144. Thus, in this example, ray 220 may be deflected zenithwards to produce one edge of the field of regard of the system, at −2° for example, (ray 220a), or horizonwards as represented by ray 220b. Ray 220 is drawn at the left edge of the device to show the size needed for componentry to accept this extreme leftwards ray. Similarly, ray 230 represents the optical beam steered at the right steering limit (e.g., +24°) from the pre-director 110, which is deflected by the first and second polarization gratings 210, 215, and incident on the field-of-regard switch 140. Ray 230 may then be deflected zenithwards (represented by ray 230a) or horizonwards (represented by ray 230b) by the field-of-regard switch 140, to produce another edge of the field of regard, at +92° for example. Ray 240 represents a central (or primary boresight) ray exiting the pre-director 110 at 0°, which is similarly deflected by the beam bender and then switched by the field-of-regard switch 140, as discussed above. Thus, in this example, hyper-hemispherical field of regard coverage, for example, approximately −2° to +92° (relative to the zenith) may be achieved.

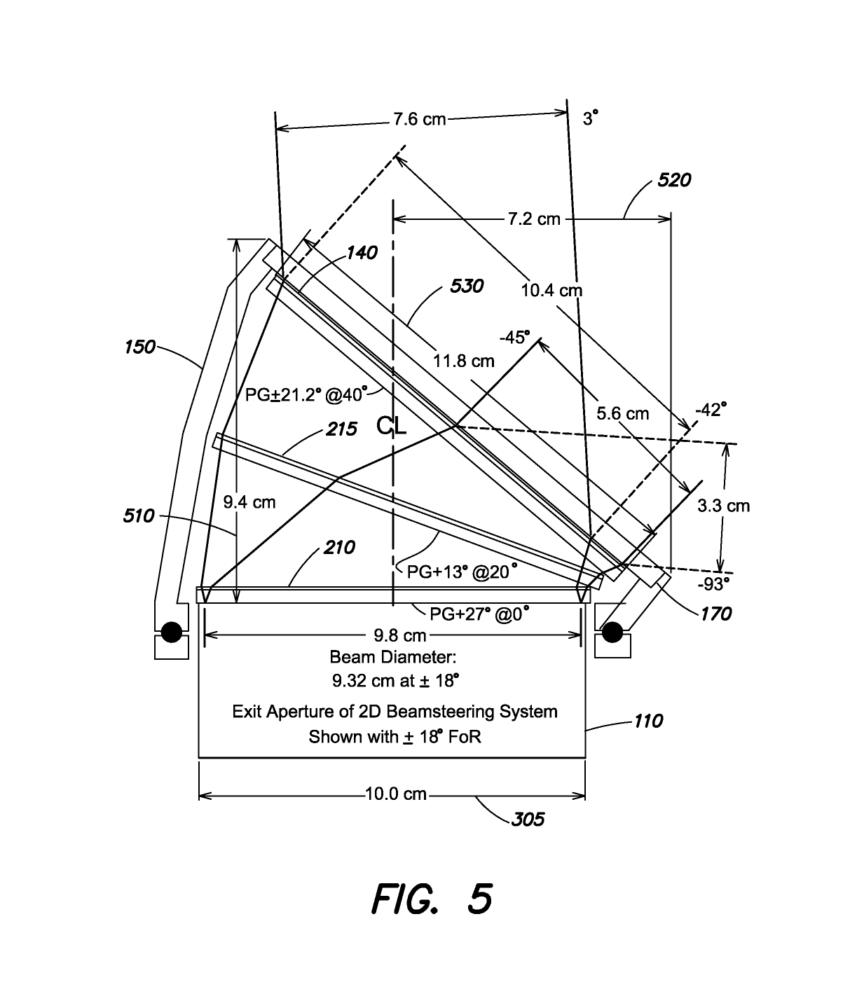

FIG. 5 illustrates an example of the beam director of FIG. 2 showing some numerical examples of the configuration of various components of the beam director system selected to achieve hyper-hemispherical coverage. In this example, the beam bender is again contained within the rotatable housing 150 and coupled to the pre-director 110. FIG. 5 illustrates an example of the field of regard coverage that may be obtained using two polarization gratings 210, 215 to implement the beam bender, with the same example of the pre-director 110 discussed above with reference to FIG. 3. Specifically, in this example, the pre-director 110 is configured to steer the optical beams over ±18° and the beam diameter at the exit aperture is 9.32 cm. In this example, the first polarization grating 210 is configured to deflect the optical beam by 27° (if it is incident normally) and is arranged at an angle of 0°, therefore aligned with the exit aperture of the pre-director 110. The second polarization grating 215 is placed at an angle of 20° and configured to deflect the optical beams by a further 13°. The field-of-regard switch 140 is positioned at 40° and includes a switchable half-wave plate and also a polarization grating configured to deflect the optical beams ±21.2° depending on the polarization of the incident beams.

With this configuration, the beam director may achieve hyper-hemispherical field of regard coverage extending from +3° to −93°, as in the prism-based example discussed above. However, the overall physical structure may be more compact than the prism-based example. For the example illustrated in FIG. 5, the dimensions of the structure are 9.4 cm (height 510) by 7.2 cm (radius 520), with a linear dimension 530 of 11.8 cm for the field-of-regard switch 140. The beam diameters are again comparable to the size of the structure for each of the limit configurations. For example, referring to FIG. 5, for a beam diameter of 9.32 cm at the exit aperture of pre-director, steered at ±18°, the beam diameter exiting the window 170 ranges between 3.3 cm (corresponding to right steering of the beam by the pre-director 110 and horizonwards directing of the beam by the field-of-regard switch 140) and 10.4 cm (corresponding to left steering of the beam by the pre-director 110 and horizonwards directing of the beam by the field-of-regard switch 140). For left steering of the beam by the pre-director 110 and zenithwards directing of the beam by the field-of-regard switch 140, the beam diameter in this example is 7.6 cm, and for right steering of the beam by the pre-director 110 and zenithwards directing of the beam by the field-of-regard switch 140, the beam diameter in this example is 5.6 cm.

Thus, aspects and embodiments provide a beam director system capable of achieving a hyper-hemispherical field of regard with a compact structure that can use a flat window, avoiding the need for the bulky, non-aerodynamic structure of turret-based systems. As discussed above, the use of a polarization grating and half-wave plate to implement a field-of-regard switch provides an easily selectable, and optionally large, angular deflection which combined with a rotating mounting platform may support complete hemispherical coverage.

Having described above several aspects of at least one embodiment, it is to be appreciated various alterations, modifications, and improvements will readily occur to those skilled in the art.

Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A beam director comprising:
a pre-director having a first field of regard and configured to steer an optical beam over the first field of regard;
a beam angle magnifier coupled to the pre-director and including a beam directing apparatus and a field-of-regard switch, the beam angle magnifier configured to expand the first field of regard to a second field of regard larger than the first field of regard, wherein the beam directing apparatus is configured to receive the optical beam from the pre-director and to alter a pointing direction of the optical beam, and the field-of-regard switch configured to receive the optical beam from the beam directing apparatus, and to direct the optical beam into one of first and second bands of coverage within the second field of regard; and
a rotatable housing, the beam angle magnifier being disposed within the rotatable housing.

2. The beam director of claim 1, wherein the field-of-regard switch includes a polarization grating and is configured to direct the optical beam into the one of the first and second bands of coverage based on a polarization of the optical beam.

3. The beam director of claim 2, wherein the beam directing apparatus includes at least one prism.

4. The beam director of claim 3, wherein the at least one prism includes three prisms optically coupled together in series, each configured to alter the pointing direction of the optical beam by a predetermined amount.

5. The beam director of claim 2, wherein the field-of-regard switch further includes a half-wave plate coupled to the polarization grating.

6. The beam director of claim 5, wherein the beam directing apparatus includes at least one additional polarization grating.

7. The beam director of claim 6, wherein the at least one additional polarization grating includes two additional polarization gratings optically coupled together in series, each configured to alter the pointing direction of the optical beam by a predetermined amount.

8. The beam director of claim 5, wherein the half-wave plate is a liquid crystal switchable half-wave plate.

9. The beam director of claim 1, further including a window coupled to the rotatable housing and optically transmissive to the optical beam.

10. The beam director of claim 1, wherein the second field of regard is at least ±60°.

11. The beam director of claim 1, wherein the second field of regard is at least ±90°.

12. The beam director of claim 1, wherein the pre-director includes a two-dimensional beam steering apparatus.

13. The beam directed of claim 1, wherein the pre-director includes one of a single prism and a single grating configured to steer the optical beam along a circular or oval path.

14. A method of beam-steering in an optical system, the method comprising:
steering an optical beam over a first field of regard with a pre-director;
receiving the optical beam from the pre-director and deflecting the optical beam to expand the first field of regard to a second field of regard larger than the first field of regard; and
directing the optical beam with a polarization grating into one of first and second bands of coverage within the second field of regard based on a polarization of the optical beam.

15. The method of claim 14, wherein deflecting the optical beam includes passing the optical beam through at least one prism.

16. The method of claim 15, wherein directing the optical beam further includes switching the polarization of the optical beam with a switchable half-wave plate positioned optically before the polarization grating to select the one of the first and second bands of coverage.

17. The method of claim 16, wherein deflecting the optical beam includes passing the optical beam through at least one additional polarization grating, and wherein the switchable half-wave plate is positioned between the polarization grating and the at least one additional polarization grating.
